(19) United States
(12) Patent Application Publication
(10) Pub. No.: US 2007/0207747 A1
(43) Pub. Date: Sep. 6, 2007

(54) Single frequency duplex radio link

(76) Inventors: Paul Johnson, El Cajon, CA (US); Ky-Hien Do, Kihei, HI (US)

Correspondence Address: TREX ENTERPRISES CORP., 10455 PACIFIC COURT, SAN DIEGO, CA, 92121, US

(21) Appl. No.: 11/652,799

(22) Filed: Jan. 12, 2007

Related U.S. Application Data
(63) Continuation-in-part of application No. 11/603,582, filed on Nov. 22, 2006.
(60) Provisional application No. 60/779,791, filed on Mar. 6, 2006.

(51) Int. Cl. H04B 1/44

(52) U.S. Cl. 455/78

(57) ABSTRACT

A radio link with two communicating transceivers each having a system for isolating incoming and outgoing radio signals to permit simultaneous transmit and receive by each transceiver on the same frequency or in the same frequency range. This is done so that in-coming receive signals received by each of the transceivers from the other transceiver is much stronger than the portion of its own transmitted signal that is coupled back into its antenna. The invention uses a special electronic circuit, termed the iso-circulator, to couple the antenna to both the co-located receiver and the transmitter. The iso-circulator circuit includes a simulated antenna load with an impedance matched to the antenna impedance. The circuit also includes a transformer with its primary side fed asymmetrically by the antenna so that it can pass the desired receive signal with minimum attenuation. The transformer's primary is on the other hand fed symmetrically from both sides by equally small portions of the transmit power from the co-site transmitter, but these signals are 180 degrees out of phase and cancel almost completely in the transformer.

This application claims the benefit of U.S. Provisional Applications No. 60/779,791 filed on Mar. 6, 2006, and is a continuation in part of U.S. patent application Ser. No. 11/603,582, filed Nov. 22, 2006. This invention relates to radio systems and in particular radio systems having features to minimize radio interference.

### BACKGROUND OF THE INVENTION

In many radio communications systems it is desirable to maintain continuous bi-directional data transfer (full duplex operation) between two stations. Cellular telephone systems and wireless computer networking systems are examples of two such systems. Currently, in these applications, maintaining the full duplex mode of operation requires that the telephone or radio modem transmit on one frequency range (or band) and receive on another frequency range. This technique is termed frequency diversity. For instance, a cellular telephone may operate in a frequency range around a nominal 800 MHz. That range may extend from about 790 MHz to 810 MHz. The particular telephone may transmit in the lower region of the 800 MHz frequency range (for example 792 MHz to 798) while simultaneously receiving in the upper region of the 800 MHz frequency range (for example 802 MHz to 808 MHz). The frequencies used are usually separated by an adequate guard-band (in this example 798 MHz to 802 MHz) so that frequency-selective filters can be used to isolate the transmitter from the receiver while at the same time coupling both the transmitter and receiver to a common antenna. This approach is also known as frequency diplexing. Other techniques, such as the use of circulators, time diversity techniques, spread spectrum codes, or polarization selectivity, have also been employed to separate the transmit signals from the receive signals for full duplex operation, over a single antenna.

During full duplex operation it is crucial that the desired signal from the antenna that appears at the receiver input be stronger than the leakage signal from the transmitter (at the receiving frequency) that also appears at the receiver input. For a typical 1-watt (+30 dBm) transmitter, and a received signal strength of −70 dBm at the antenna, the transmitter power at the receiver's frequency must be suppressed by at least 100 dB at the input to the receiver. This is usually achieved by requiring that transmitters have strict limitations on out-of-band emissions, by receiving in a frequency band isolated and separate from that of the transmitter, and by employing high gain antennas to boost the received signal power. If the transmitter power is not suppressed sufficiently at the receiver input, then the sensitivity of the receiver is deteriorated, even though operation may still be possible at some impractically high receive signal levels. Power levels at the receiver input from communication signals captured by the antenna are often in the range of −90 to −20 dBm, so insufficient suppression of the transmitter output will limit the useful range of the receiver and the distance over which full duplex radio communication may be established.

In military radios, due to the spread-spectrum coding and modulation schemes, the signals are spread over several octaves of bandwidth and are at power levels reaching hundreds of watts in CW. For example, the military SINCGARS radios operate in the 30-88 MHz range at a maximum output power of 50 W per radio. In a cluster of 4 radios, operating simultaneously on a vehicular platform, there exists a worst-case scenario, in which 1 radio is receiving and 3 radios are transmitting, that produces 150 W of transmitting power to interfere with the receiving radio. The issues of co-site interference here are prevalent and enormous. A solution to these co-site issues is the iso-circulator.

Circulators are known in the industry and provide a means of coupling both a transmitter and a receiver to a common antenna. A circulator is a three-port ferrite (magnetic) device that operates over some RF (radio frequency) bandwidth, and is illustrated schematically in FIG. 1. A circulator preferentially and circularly transfers power from Port 1 to Port 2, from Port 2 to Port 3, and from Port 3 to Port 1, hence the name. Power input to Port 1 of a circulator will appear mostly at Ports 2 and very little at Port 3. Typically, about 20 dB less of input power appears at Port 3. FIG. 2 shows Circulator 14 used to isolate a transmitter from a receiver, and to couple both to a common antenna. In this instance, the circulator provides 20 dB of isolation between the transmitter and receiver. 20 dB of isolation is usually insufficient to prevent power from the transmitter from interfering with a desired signal received from the antenna, so bandpass filters 15 and 16 are added to the transmit and receive signal paths, and frequencies of operation are chosen such that the transmitter signal passes through bandpass filter 15, but is blocked by bandpass filter 16, which in turn only passes the received signal from the Antenna 3. The use of bandpass filters 15 and 16 can suppress the transmitter power that enters the receiver by another 40 dB. This improves the isolation between transmitter and receiver to 60 dB, which is often enough to allow simultaneous transmission and reception of signals. This prior art implementation requires the use of widely separated frequencies for transmit and receive, to take advantage of the isolation provided by bandpass filtering. However, magnetic circulators are not available at all frequency ranges, especially at VLF, LF, HF, VHF and UHF bands, and even if available they do not cover a wide bandwidth and can not handle high power.

Antenna polarization selectivity can be used to provide isolation between transmitter and receiver in a full duplex radio, but similar to the circulator approach described above, polarization selectivity usually provides only about 20 dB of isolation between the transmitter and the receiver. Systems which use polarization selectivity to isolate the transmitter and receiver usually also separate the frequencies of operation and employ band pass filtering on the transmitter output and receiver input to provide additional isolation.

FIG. 3 shows the circuit schematic of a Wilkinson divider. These dividers are sometime called “splitters”. Radio power dividers of this type were described in a 1959 paper by Ernest J. Wilkinson. FIG. 3 shows features of a 3-port Wilkinson divider available from suppliers such as Werlatone with offices in Brewster N.Y. These devices can be used as a power splitters as well as power combiners.

Prior art patents describing techniques for providing isolation include U.S. Pat. No. 4,051,475, Radio Receiver Isolation System issued to Campbell; U.S. Pat. No. 4,174,506, Three-port lumped-element circulator comprising bypass conductor issued to Ogawa; and U.S. Pat. No. 4,704,588, Microstrip Circulator with Ferrite and Resonator in Printed Circuit Laminate issued to Kane. No prior art has been shown to adequately address interference mitigation for a system in which a co-sited transmitter is operating at the same frequency as the receiver.

What is needed is a better system for providing transmitter to receiver isolation.

### SUMMARY OF THE INVENTION

The present invention provides a radio link with two communicating transceivers each having a system for isolating incoming and outgoing radio signals to permit simultaneous transmit and receive by each transceiver on the same frequency or in the same frequency range. This is done so that in-coming receive signals received by each of the transceivers from the other transceiver is much stronger than the portion of its own transmitted signal that is coupled back into its antenna. The invention uses a special electronic circuit, termed the iso-circulator, to couple the antenna to both the co-located receiver and the transmitter. The iso-circulator circuit includes a simulated antenna load with an impedance matched to the antenna impedance. The circuit also includes a transformer with its primary side fed asymmetrically by the antenna so that it can pass the desired receive signal with minimum attenuation. The transformer's primary is on the other hand fed symmetrically from both sides by equally small portions of the transmit power from the co-site transmitter, but these signals are 180 degrees out of phase and cancel almost completely in the transformer. The iso-circulator works in an unsymmetrical manner as far as the desired receive signal is concerned and in a symmetrical manner as far as the undesired co-site transmit signal is concerned, so that the receiver connected to the secondary side of the transformer receives the desired signal from the remote radio at a much higher sensitivity than it receives the leakage portion of the co-site transmit signal. Thus the invention provides a reduction in excess of 60 to 70 dB in the strength of the co-site transmitter signal at the receiver input, while leaving the signal captured by the antenna reduced by only 1 dB at the input to the receiver electronics.

### BRIEF DESCRIPTION OF THE DRAWINGS

FIG. 1 shows a prior art circulator.

FIG. 2 shows a prior art circulator located in a transceiver system.

FIG. 3 shows features of a prior art Wilkinson divider.

FIG. 4 is a block diagram showing features of the present invention.

FIG. 5 shows more details an embodiment of the present invention.

FIGS. 6a, 6b and 6c show how radio energy circulates in the present invention.

FIG. 7 shows test results showing isolation of more than 70 dB in an idealized situation.

FIG. 8 shows a preferred radio link according to the present invention.

FIG. 9 shows more details of a preferred embodiment of the present invention.

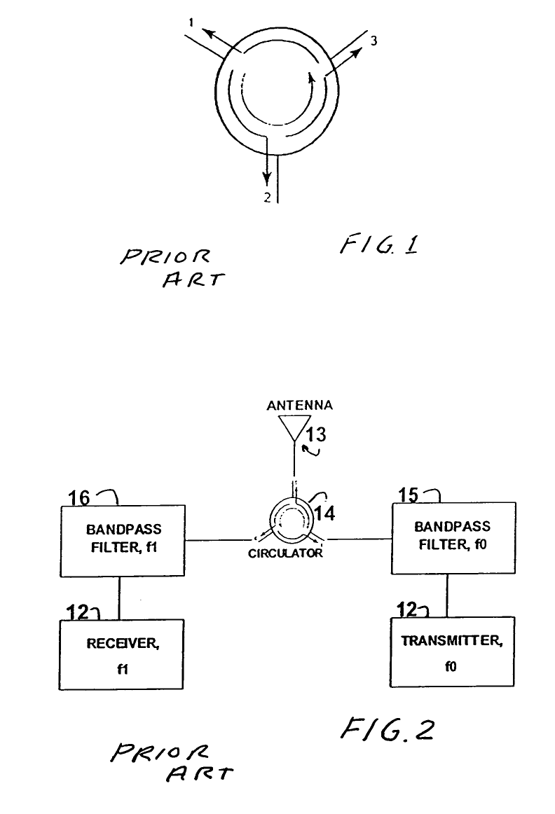

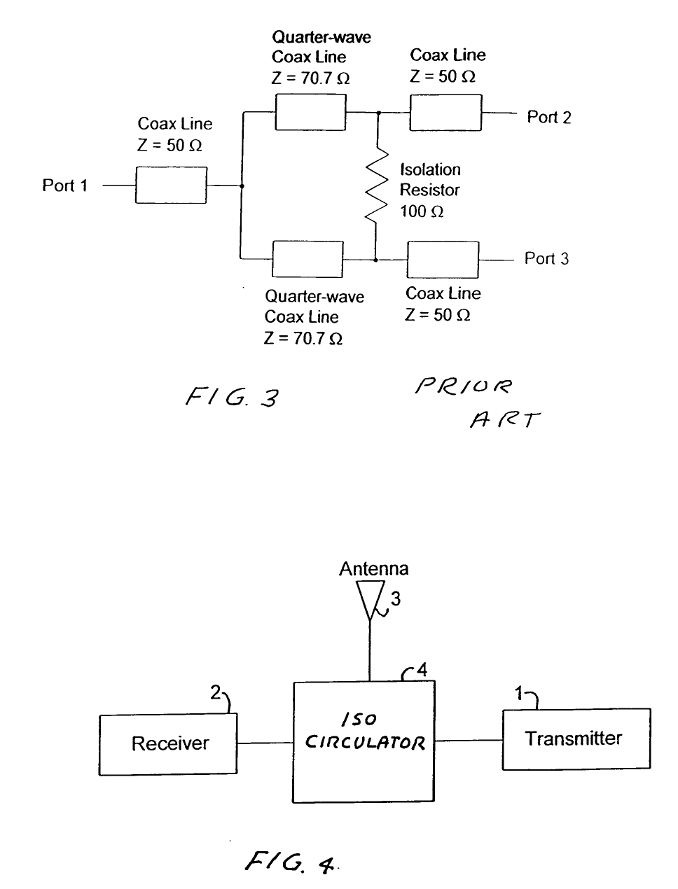

### DETAILED DESCRIPTION OF THE PREFERRED EMBODIMENT

With reference to FIG. 4, the preferred embodiment of the present invention is comprised of radio transmitter 1, radio receiver 2, antenna 3, and ‘iso-circulator’ 4. In a preferred embodiment the radio would be configured to simultaneously transmit and receiver computer network data at 100 Mbps (each direction) in the license-free 2.4 GHz ISM (Industrial/Scentific/Medical) band. Transmitter 1 and Receiver 2 are in simultaneous operation, with transmitter 1 having a center frequency of 2435 MHz and receiver 2 having a center frequency of 2435 MHz. Different spread spectrum codes and modulation techniques for the transmitted and the received signals may be employed to further enhance the separation of the transmit and receive signals beyond the 70 dB that is achieved by iso-circulator 4.

Transmitter 1, receiver 2, and antenna 3 are available from a variety of vendors and are well know to those familiar with the industry. Iso-circulator 4 is a custom-developed design based on a previously disclosed quasi-circulator invention by associates of the present inventor. A key design element of the iso-circulator is the perfect balancing of phase and amplitude throughout the system. Additionally Synthesized Antenna Load 5, approximating the load impedance of the antenna is necessary to optimize isolation.

FIG. 9 shows a detail of iso-circulator 4 as used in a Single Frequency Full Duplex radio. The transmit power from Transmitter 1 is divided equally by Power Divider 8 between radiating Antenna 3 and the Synthesized Antenna Load 5. The energy that is not transmitted through Antenna 3 or absorbed by the load 5, and some energy captured by the antenna from external sources continues to the left toward Receiver 2. The substantially equal energy is combined in Balun Transformer 6 (or similar differentially coupling device) with one port 180 degrees out of phase with the other. The differential ports of the Balun transformer thus cancel the energy from the two similar paths (from the transmitter) and connect the single ended port (from the antenna) to receiver 2. Thus, assuming good phase and amplitude matching between the top path from transmitter to receiver (containing the antenna), and the bottom path from transmitter to receiver (containing the Synthesized Antenna Load 5), most of the transmit energy that would otherwise enter the receiver is canceled before it enters the receiver, yet the receiver and transmitter are connected to the same antenna. An additional benefit of the system is that reflections from antenna mismatch, and any noise or harmonics introduced by the power amplifiers in the transmitter are also canceled or reduced before entering the receiver.

With reference to FIG. 9, the captured energy from Antenna 3 passes through Circulator 10a and appears preferentially at the left side of Circulator 10a where it is presented to the top of Balun Transformer 6. Some of the captured antenna power appears at the right side of Circulator 10a (reduced in amplitude by approximately 20 dB) and continues down the right side path through Splitter 8, Circulator 10b, Antenna Load 5, and Circulator 10b again, before finally reaching the bottom of Balun Transformer 6. By the time the power taking this right hand path reaches Balun Transformer 6, it is much lower in power than that taking the preferential left hand path through Circulator 10a and the left hand path to Balun Transformer 6. The paths of these networks are not symmetrical. Since the two signals (from the antenna) are greatly out of amplitude balance, there is little or no cancellation by the transformer of the signals captured by the antenna.

FIG. 5 shows a more basic implementation of the iso-circulator as used in a full duplex radio. In the basic quasi-circulator, Circulators 10a and 10b (in FIG. 10) are replaced by Power Dividers 9a and 9b. This has the effect of increasing loss between the antenna and the receiver to approximately 3 dB, and increasing the loss between the transmitter and antenna to 6 dB. These undesirable effects may be offset in some applications by achieving a broader operational bandwidth (multi-octave or decade). It is often found that Power Splitters 8, 9a, and 9b may by operated over a 10:1 range of frequencies, whereas Circulators 10a and 10b may operate over only a 3:1 range of frequencies (or less).

### Wilkinson Divider

As shown in FIG. 9, an off-the-shelf three-port Wilkinson divider 8 is used as a power splitter. Details of the Wilkinson divider are shown in FIG. 3. Each port of the Wilkinson divider is of 50-Ohm characteristic impedance. Port 1 is connected to Port 2 by a quarter-wave transmission-line transformer of 70.7-Ohm characteristic impedance. Port 1 is similarly connected to Port 3 by a quarter-wave transformer of 70.7-Ohm characteristic impedance. Port 2 and Port 3 are separated by an isolation resistor of 100-Ohms. When a signal enters Port 1, it will be split evenly between Port 2 and 3. The power levels at Port 2 and 3 are half (3 dB down) of the input power less by the insertion loss of the device. Typically, in practical implements of the Wilkinson divider, the power at Port 2 or 3 is 3.2 dB down from the input power at Port, with 0.2 dB being attributed to insertion loss. When a signal enters either Port 2 (or Port 3), half of the input power less the insertion loss appears at Port 1 and very little appears at Port 3 (or Port 2). Port 2 and Port 3 are thus isolated from one another. The isolation between Port 2 and Port 3 are due to the phasing effects of the two 70.7-Ohm quarter-wave transformers and 100-Ohm resistor. Intuitively, each quarter-wave section adds a 90 degree phase shift to the signal traveling along it. Two quarter-wave sections therefore insert a phase shift of 180 degrees. A signal traveling through the two quarter-wave sections thus cancels with its equal counterpart which in turn travels directly across the resistor. This cancellation causes the desired isolation effect in the Wilkinson divider. Typically, in practical implements of the Wilkinson divider, the isolation between Port 2 and 3 is in the order of 30 dB.

### Circling Signals

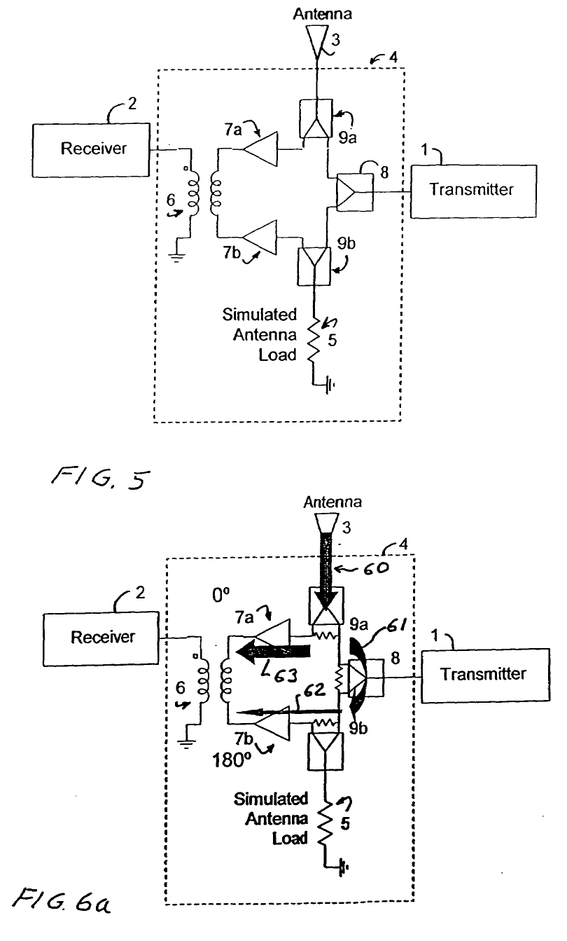

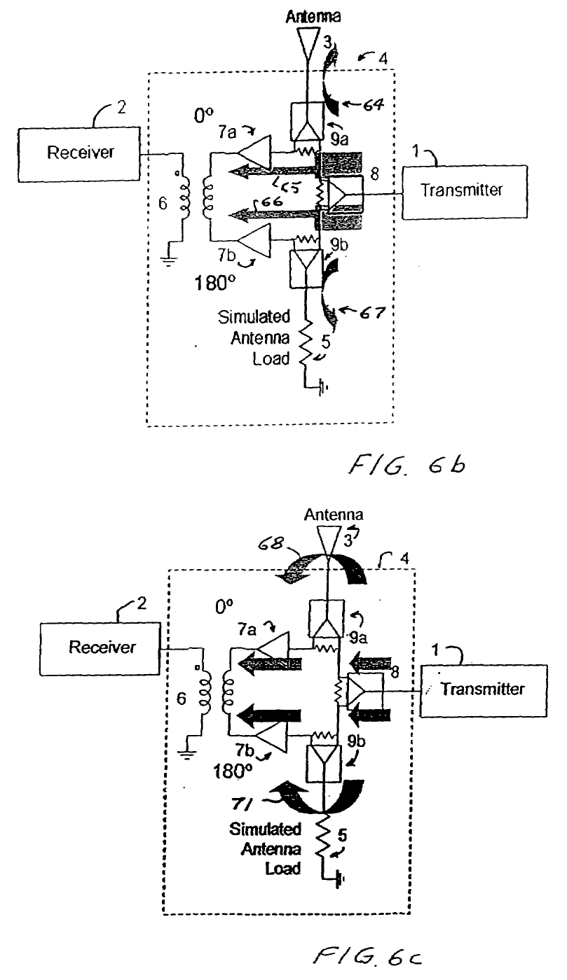

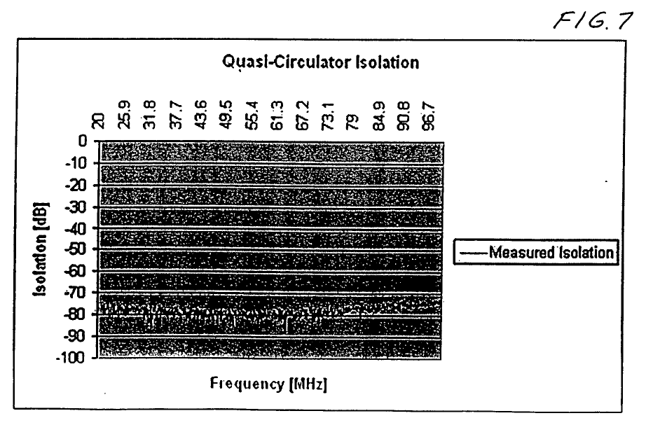

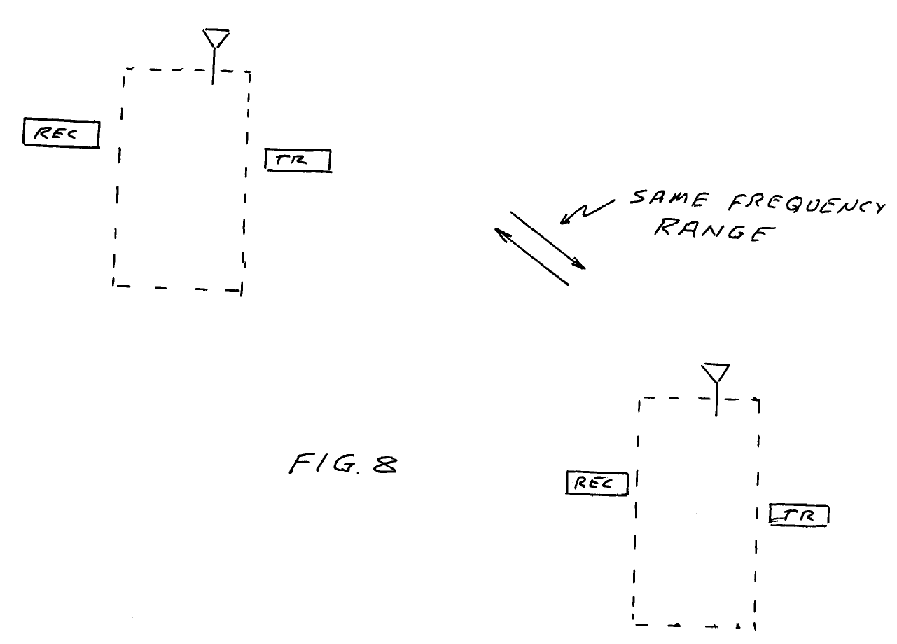

With reference to FIG. 6a, a simplified version of the iso-circulator, in which circulators 10a (FIG. 9) and 10b (FIG. 9) are replaced by power splitters 9a and 9b, the captured energy from antenna 3 (arrow 60) passes through splitter 9a and almost one half appears at the left side of splitter 9a where it is amplified by low noise amplifier 7a and presented to the top of balun transformer 6. This is represented by the thick arrow 63 pointing from right to left, along the top path of FIG. 6a. Almost one half of the captured antenna energy appears at the right side of Splitter 9a and continues down the right side path through splitter 8 (arrow 61), splitter 9b, and low noise amplifier 7b (arrow 62), before finally reaching the bottom of balun transformer 6. By the time the power taking this right hand path reaches the bottom of balun transformer 6, it is much lower in magnitude (the reduction is estimated to be greater than 50 dB) than that taking the preferential left hand path through Splitter 9a to the top of balun transformer 6. The reduction in power of the signal along the bottom path is due to the isolations of the power dividers. The paths of these signals, originated from antenna 3, are not symmetrical thus allow the propagation of the received signal to the intended destination which is receiver 2. Since the two signals along the top and bottom path are greatly out of amplitude balance, there is only a 3 dB reduction in power of the received signal, captured at antenna 3, as it reaches receiver 2.

### Co-Site Transmitter Power is Cancelled in Iso-Circulator

Similarly, as shown in FIG. 6b, the transmit power from transmitter 1 is divided equally by power divider 8, 9a and 9b between the radiating antenna 3 and the simulated antenna load 5. These are illustrated by the two arrows 64 and 67 pointing toward antenna 3 and simulated load 5 and 65 and 66 pointing from right to left, one along the top path and the other bottom path. The change in the arrow thickness of 65 and 66 visually illustrates the effect of reduction in leakage power due to the isolations of power divider 9a and 9b, although the drawings are not to scale. The amount of energy that is not radiated into the air through Antenna 3 or absorbed by simulated antenna load 5 or absorbed in the isolation resistors of the Wilkinson splitters, travels to the left toward receiver 2. These two substantially equal signals, along the top path 65 and bottom path 66, are combined in balun transformer 6 with one side 180 degrees out of phase with the other. The differential ports of the balun transformer 6 thus cancel the energy from the two identically similar paths from the co-site transmitter 1 to receiver 2. Thus, with good phase and amplitude matching between the top path—from transmitter 1 to receiver 2 (containing Antenna 3)—and the bottom path—from transmitter 1 to receiver 2 (containing simulated antenna load 5), most of the co-site transmit energy that would otherwise leak over to the receiver is cancelled before it enters receiver 2, even though receiver 2 and transmitter 1 are physically allowed to share the same antenna.

### Cancelling Unwanted Signals

An additional benefit of the iso-circulator is the return loss from antenna 3 mismatch, and any noise or harmonics introduced by amplifiers in transmitter 1 are also cancelled or substantially reduced before entering receiver 2. FIG. 6c illustrates how reflected energy (arrow 68) from Antenna 3 can be imitated by the use of simulated antenna load 5 (arrow 71) so that the reflection of the antenna can also be cancelled before it enters the receive radio. In the preferred embodiment, the simulated antenna load 5 is a static circuit which possesses the same reflection coefficient as that of the antenna. However, in other embodiments, simulated antenna load 5 can be a dynamically tunable circuit that imitates the operations of an antenna on the move or within a varying surrounding. The simulated antenna load 5 is therefore a powerful feature which allows an advantageous degree of freedom for dealing with practical environmental effects. This environment-mitigation feature is unique to the quasi-circulator and very powerful in breadth of applications.

In other words, the simulated antenna load 5 can be utilized to approximate the response of the antenna in both the static and dynamic senses. In the static sense, the matched load can be manufactured to offer the impedance response that is precisely that of the antenna, as measured within an anechoic chamber, over the frequency band of interest and at the rated power level. This configuration of the matched load is basic in nature and can be used in most common scenarios. However, when a communication system is intended for a mobile application, the platform upon which the iso-circulator antenna are mounted operates dynamically. In the dynamic sense, the antenna radiation pattern and reflection are strong functions of the surroundings. Applicant envisions that in such cases, the matched load can be dynamically optimized by means of a calibration algorithm before each use or periodically during operation. The calibration routine is a test sequence that can be devised to take into account the operational characteristics of the antenna along with the environmental effects of surroundings and circumstances. Once the calibration routine is exercised, the matched load can be considered to be the most optimized representation of the antenna under the circumstances of deployment, over the frequency band of interest and at the rated power level. The goal of the optimization routine is for maximum transmitter-to-receiver isolation. The means with which the matched load is to be optimized are resistor, inductors, capacitors and transmission lines that are variable in values, phases and characteristic impedances. These variable components are needed so that both the magnitude and phase of the impedance offered by the matched load are tunable. The optimization is performed by varying antenna matched load circuit component values while the transmitter is operating in such a manner as to minimize the amount of power (from the transmitter) measured at the receiver.

### Net Result

The net result from the implementation of the preferred embodiment of the invention is a reduction of the leakage from the co-site transmitter to the receiver by 60 to 70 dB or more, while reducing the desired received signals from the antenna to the receiver by only 1 dB. Since the signal emitted by transmitter 1 is split between antenna 3 and matched antenna load 5, by traversing through a power splitter, the transmitter power delivered to antenna 3 is reduced by 3 dB. In preferred embodiments the radios would be configured to simultaneously transmit and receive voice and/or data over the exact same bandwidth. Iso-circulator 4 operates on the concept of passive cancellation due to symmetry, hence is signal waveform independent. However, different spread spectrum codes and modulation techniques for the transmitted and the received signals may be employed to further enhance the isolation of the co-site transmit and receive signals beyond the 70 dB that is achieved by iso-circulator 4.

### Transmitting and Receiving in the Same Frequency Range

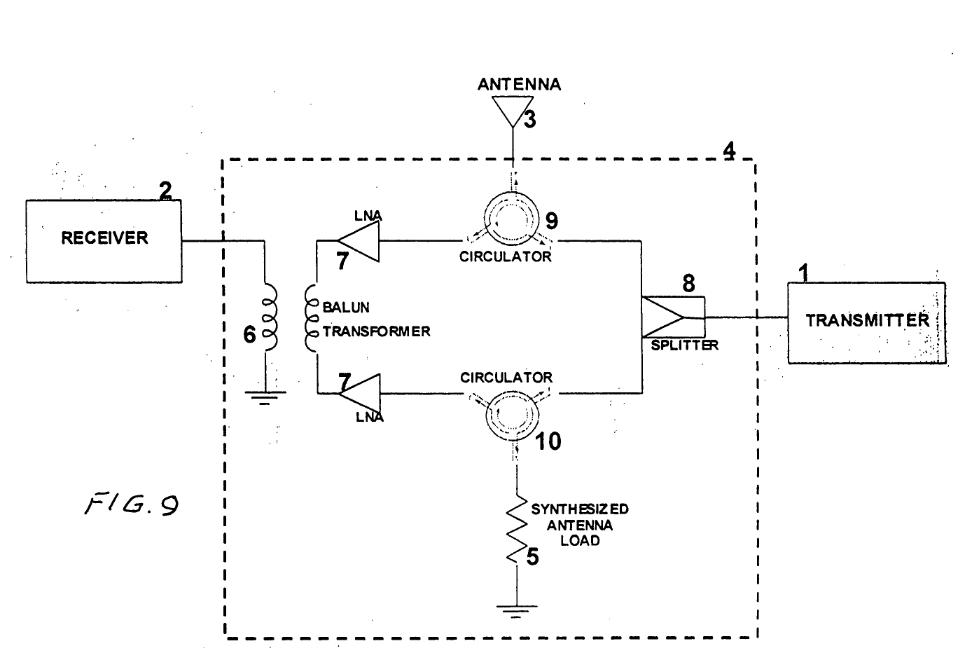

In the parent application Ser. No. 11/603,582, this invention was applied to permit two or more radios to operate at the same location in the same or very nearby frequency bands. The present invention provides a radio link with each of the two transceivers at opposite ends of the link operating simultaneously in the exact same frequency band. A preferred link is shown in FIG. 8. Here both transceiver 80 and transceiver 82 are transmitting and receiving simultaneously in the frequency range of 2400 MHz to 2500 MHz. Each of the two transceivers are equipped with an iso-circulator, to couple the antenna to both the co-located receiver and the transmitter. As explained above each of the iso-circulator circuits includes a simulated antenna load having an impedance matched to the antenna impedance. The circuit also includes a transformer with its primary side fed asymmetrically by the antenna so that it can pass the desired receive signal with minimum attenuation. The transformer's primary is on the other hand fed symmetrically from both sides by equally small portions of the transmit power from the co-site transmitter, but these signals are 180 degrees out of phase and cancel almost completely in the transformer. The iso-circulator works in an unsymmetrical manner as far as the desired receive signal is concerned and in a symmetrical manner as far as the undesired co-site transmit signal is concerned, so that the receiver connected to the secondary side of the transformer receives the desired signal from the remote radio at a much higher sensitivity than it receives the leakage portion of the co-site transmit signal. Thus the invention provides a reduction in excess of 60 to 70 dB in the strength of the co-site transmitter signal at the receiver input, while leaving the signal captured by the antenna reduced by only 1 dB at the input to the receiver electronics.

### Modifications and Improvements

Those who are skilled in the art can reference the schematic diagrams shown in FIG. 5 and FIG. 9 and use a variety of circuit elements to practice the present invention. Certain modifications and improvements will therefore occur to those skilled in the art upon reading the foregoing description. The embodiment described herein is based on a specific architecture but the present invention is not so limited, however.

Also, those are skilled in the art will recognize that the circuit elements as shown in FIG. 5 and FIG. 9 are conventional splitters, circulators, hybrid transformer, resistive load and low noise amplifiers which are commercially available through numerous suppliers. Therefore, those skilled in the art can readily realize the iso-circulator by purchasing, and assembling these components, from companies such as Anaren, Filtran, MIA-COM, MCCI, Mini-circuits, or Werlatone. It must be noted that the catalog of companies listed here is not exhaustive by any means. It is included here to illustrate the fact that the components employed in the construction of the iso-circulator are common and basic components which are widely available in the RF and microwave industry.

Certain other modifications and improvements will therefore occur to those skilled in the art upon reading the foregoing description. The embodiment described herein is based on a specific architecture but the present invention is not so limited. As indicated above the present invention can be utilized in addition to other well-known radio isolation techniques. It should be noted that the catalog of companies listed here is not exhaustive by any means. It is included here to illustrate the fact that the components employed in the construction of the quasi-circulator are common and basic components which are widely available in the radio frequency and microwave industry. The techniques can also be applied to produce jamming devices to jam other radios while leaving a receiver isolated from the jamming noise. So the scope of the invention should be determined by the appended claims and their legal equivalence.

What is claimed is:

1. A radio link radio link with two communicating transceivers each having a system for isolating incoming and outgoing radio signals to permit simultaneous transmit and receive by each transceiver in the same frequency range, said radio link comprising:
A) a transmitter,
B) an antenna, defining an antenna electrical impedance within said radio frequency range,
C) a iso-circulator comprising:
1) a matched electrical load having an electrical impedance substantially matched to said antenna electrical impedance,
2) a radio signal splitter adapted to split incoming radio power signals into two substantially equal outgoing radio power signals,
3) a transformer defining a primary and a secondary coil,
4) a circulator coupling said antenna to said splitter and said transformer, and
5) a second circulator coupling said matched electrical load to said splitter and said transformer.
wherein the three radio signal splitters and said transformer are arranged produce:
(i) a circulation within said iso-circulator of about one-half of output power of said co-located transmitter in a first direction and a circulation of about one-half of said output power of said co-located transmitter in a second direction opposite said first direction and
(ii) a circulation within said iso-circulator of about one-half of input power received by said antenna in said first direction and a circulation of one-half of said input power received by said antenna said second direction;
with said transformer positioned within said quasi-circulator so that substantially all output power of said transmitter that is not otherwise transmitted or dissipated is cancelled in said transformer, and
D) at least one receiver adapted to receive remote radio power signals from the other transceiver at an output of said secondary coil of said transformer, wherein said remote radio power signals received by said receiver is significantly greater than radio power signals received by said receiver from said transmitter.

2. The radio link as in claim 1 wherein said iso-circulator also comprises two radio signal amplifiers for amplifying radio signals at two inputs to the primary side of said transformer.

3. The radio link as in claim 1 and further comprising a radio signal amplifier positioned to amplify output signals from said secondary side of said transformer.

4. The radio link as in claim 1 wherein said radio signal splitter is a Wilkinson divider.

5. The radio link as in claim 4 wherein said Wilkinson divider is a three-port divider with each port having a 50-Ohm characteristic impedance and each divider having a port connected to two other ports with a quarter-wave transmission line transformer of about 70.7 Ohm characteristic impedance, wherein the other two ports are separated by an isolation resister with an impedance of about 100 Ohms.

6. The radio link as in claim 1 wherein said transformer is a balun transformer.

7. The radio link as in claim 6 wherein one of two secondary terminals of said transformer is grounded.
